(19) United States
(12) Patent Application Publication
(10) Pub. No.: US 2013/0186427 A1
(43) Pub. Date: Jul. 25, 2013

(54) DENTAL INSTRUMENT FOR CLEANING TEETH

(71) Applicant: Antonio Monicelli, San Giovanni alla Vena - Vicopisano (PI) (IT)

(72) Inventor: Antonio Monicelli, San Giovanni alla Vena - Vicopisano (PI) (IT)

(21) Appl. No.: 13/811,411

(22) PCT Filed: Jul. 22, 2011
(86) PCT No.: PCT/IB2011/001710

§ 371 Date: Mar. 12, 2013

(30) Foreign Application Priority Data
Jul. 22, 2010 (IT) PI2010A000089

(51) Int. Cl. A61C 15/04

(52) U.S. Cl. CPC A61C 15/047
USPC 132/322

(57) ABSTRACT

A dental instrument (1) for oral hygiene comprises a handpiece (10) having motor means (15) that is adapted to wheel a drive shaft (20) about a rotation axis (21). The dental instrument (1) comprises, furthermore, a cleaning element (40), in particular, with elongated shape and flexible, that is adapted for cleaning the dental surface and interdental spaces of a patient (100). Means for transmitting the movement (70) transmit the movement of the drive shaft (20) to the elongated cleaning element (40). The means for transmitting the movement (70) comprises an eccentric portion (75), whose axis (76) is arranged at a distance (δ) from the axis (21) of the drive shaft (20). Therefore, during the rotation of the drive shaft (20) about its axis (21), the eccentric portion (75) oscillates with a desired oscillation amplitude (2δ). To the eccentric portion (75), furthermore, a support (60) is pivotally connected [FIG. 7].

### FIELD OF THE INVENTION

The present invention relates to the dental field and, in particular, it relates to a dental instrument for cleaning teeth, in particular for cleaning interdental spaces, of the dental arch of a patient.

### DESCRIPTION OF THE PRIOR ART

A variety exists of types of mechanical apparatus for cleaning the interdental spaces of a patient by means of a dental floss.

Such apparatus can be of professional type and then adapted to be handled by dentists, or dental hygienists, during teeth cleaning prophylaxis, or of household type and in this case adapted to be handled by patients. In both cases, such mechanical apparatus can be used to execute a deeper and more accurate teeth cleaning than traditional dental flossing.

An example of a mechanical apparatus for cleaning interdental spaces is disclosed in U.S. Pat. No. 5,217,031. The apparatus comprises, in particular, an outer casing having a handle, a gear motor and a geared transmission.

The apparatus comprises, also, a working head at which a dental floss is arranged supplied by a supply spool and operated providing an alternative movement for flossing the interdental spaces of a patient. The apparatus comprises, furthermore, a disposing spool for collecting the worn floss.

The gearing transmission comprises a first gear wheel that meshes with a pinion and is mounted idle to the casing. Furthermore, a second gear wheel is provided which is also mounted idle to the casing and meshes with the first gear wheel.

The geared transmission comprises then a connecting rod operated by the first gear by a crank to it integral, a first pulley mounted to the end of the connecting rod and a second pulley mounted idle to the casing in front of the second pulley. A similar tool is described also in U.S. Pat. No. 7,464,716.

Another type of teeth cleaning apparatus is disclosed in U.S. Pat. No. 5,176,157. In this case, the apparatus comprises a dental floss stretched between two branches of a fork shaped element. The dental floss is kept stretched and moved between the two branches of the fork-shaped element by a motor mounted to the apparatus and by a plurality transmission parts comprising pulleys and gear wheels.

However, the above described apparatus have high lateral size that hamper the specialist, or the user, preventing from cleaning teeth at the most concealed points of the dental arch, such as the interdental spaces of the back teeth.

Furthermore, the above described devices are structurally complex and are not capable of ensuring the necessary hygienic conditions for disposing of the dental floss already used in the casing, where bacterial plaque removed from the dental arch can pollute the dental floss not yet used.

A further known teeth cleaning apparatus provides a contra-angle handpiece assembled to an insert that in use has an eccentric portion with respect to the drive shaft of the handpiece. To the eccentric portion of the handpiece an end of an abrasive tape is connected having the other end equipped with a holding ring at which the user holds and keeps stretched the abrasive tape same during the teeth cleaning operation.

This type of apparatus is designed exclusively for a professional use and has the drawback of requiring relevant force by the forearm of the operator owing to the inclination of the head that generates a relevant force and torque, because the operator has to bend the arm and rotate the wrist of the hand that grips the handpiece for guiding the abrasive tape in the area of operation. In any case, the operator has a reduced freedom of movement and it is therefore hampered also in this case to cover the whole dental arch of the patient. Furthermore, the abrasive tape cannot floss the contact surfaces between the teeth where the bacterial plaque accumulates and can cause eventually the production of caries and the onset dental diseases of different nature. Furthermore, the elongated hole on which the eccentric rotates causes friction and then wear and overheating. This causes a break of the tape in a few seconds and then requires the frequent change of the tape before the abrasive has completed its function.

Another type of dental instrument for oral hygiene, in particular of interdental type, of a patient is disclosed in US2005/008986. In this case, the dental instrument comprises a motor having a rotating shaft, a connection element having a first and of a second end, and a motion transformation element. This is adapted to transform the rotation of the shaft into an axial movement that is transmitted to the second end of the connecting element.

### SUMMARY OF THE INVENTION

It is then a feature of the present invention to provide a dental instrument for cleaning teeth that can reach also the most hidden points of the dental arch of a patient and, in particular, the contact surfaces of two adjacent teeth.

It is another feature of the present invention to provide such a dental instrument for cleaning teeth for reducing, in operation conditions, the actions and the vibrations transmitted to the user, i.e. to the operator when cleaning the teeth of the patient.

It is also a feature of the present invention to provide such a dental instrument that can reduce the actions transmitted to the user, who can then carry out many consecutive teeth cleaning prophylaxis.

It is a particular feature of the present invention to provide an insert for a dental handpiece that has the above described advantages.

These and other objects are achieved by a dental instrument for cleaning teeth, according to the invention, comprising:
a handpiece for a user;
a motor means that is arranged to bring into rotation, with respect to said handpiece, a drive shaft about an axis of rotation;
an elongated cleaning element arranged for cleaning the interdental spaces and/or the dental surface of a patient, said elongated cleaning element being selected from the group consisting of:
   a dental floss of predetermined length;
   a tape of predetermined length;
a means for transmitting the movement of said drive shaft to said elongated cleaning element, said means for transmitting the movement comprising:
an eccentric portion of said drive shaft, wherein said eccentric portion, during the rotation of said drive shaft about said axis of rotation, can oscillate with a predetermined oscillation amplitude;
a support pivotally connected to the eccentric portion;
a connection means for connecting said elongated cleaning element to said support, said connection means arranged to support the stretched cleaning element along a predetermined stretching direction during the rotation of the eccentric portion of the drive shaft, so that the support can be kept rotationally still with respect to the user and can vibrate with respect to the user transmitting the vibration to the stretched cleaning element.

In particular, the support has a hole, said eccentric portion of the drive shaft and said support engaging pivotally with each other at said hole. For example, the support may have a substantially cylindrical shape.

In particular, the support is out of the body of the handpiece.

Advantageously, the support is a bush equipped with a hole in which the eccentric portion engages, such that the bush forms a rotatable coupling with the eccentric portion.

Advantageously, the support, or the bush, has a substantially cylindrical shape.

In particular, the cleaning element is adapted, in use, to be held by the user at a holding portion at a distance from the support for being stretched in the desired stretching direction, in order to vibrate, or oscillate, along the above described stretching direction in order to clean the dental surface and/or the interdental spaces with which it is put in contact.

Advantageously, the support is mounted to the eccentric portion with a predetermined play, such that the stretching direction of the cleaning element can be chosen in a desired way.

In particular, the transversal dimension of the hole of the support is larger than the transversal dimension of the eccentric portion, such that the support is mounted to the eccentric portion with a predetermined transversal play, in particular radial. This way, the support is movable along a transversal direction, in particular radial, with respect to the eccentric portion allowing an adjustment of the stretching direction in a desired way. The possibility of inclining the support, within determined limits, with respect to the eccentric portion allows the user to guide easily the cleaning element acting at the holding portion. This allows the user of executing easily the cleaning operation of the interdental spaces and of the dental surfaces of all the dental arch of the patient allowing to reach also the most hidden points.

In particular, said transversal or radial play, is adapted to make it possible an inclination of the support with respect to the axis of the handpiece of an angle set between +180° and −180°.

Advantageously, the transversal play, or radial, is adapted to make it possible an inclination of the support with respect to the axis of the handpiece of an angle set between +120° and −120°

Advantageously, the support engages with the eccentric portion of the drive shaft at an elongated hole.

Advantageously, the support is movable longitudinally to the eccentric portion.

In particular, the support is movable longitudinally to the eccentric portion between a first position and a second position.

Advantageously, at least at one among the first and the second position a stop element is provided that is adapted to stop the movement of the support with respect to the eccentric portion.

Advantageously, at the first and the second position a first and a second stop element are respectively provided, said first and said second stop element defining the movement of the support with respect to the eccentric portion between the first and the second position, respectively.

In particular, the first stop element can be a disc integral to the drive shaft, said disc having size larger than the hole at which the support engages with the eccentric portion of the drive shaft, such that it can stop the movement of the support along the eccentric portion of the drive shaft.

In an exemplary embodiment, the second stop element comprises a shoulder at said eccentric portion, said shoulder arranged, at said second position, to abut against a portion protruding from said hole of the support.

In particular, the hole of the support comprises:
a distal portion having a cross section with a predetermined dimension;
a proximal portion having a cross section of size less than the cross section of the distal portion, in order to form said protruding portion.

Advantageously, the shoulder is made at the end of the eccentric portion opposite to the end fastening to the drive shaft.

Advantageously, the connection means is arranged to provide a rotatable coupling between the support and the cleaning element. This way, in use, the cleaning element can be freely rotated about an axis substantially orthogonal to the drive shaft, in order to increase further the freedom of movement of the user who cleans the teeth and to eliminate the torsion which would bring the cleaning element to entangle on itself.

Advantageously, the connection means comprises an end hinged to the support, such that said elongated cleaning element can rotate with respect to the support in a plane containing the stretching direction and the drive shaft.

In particular, the connection means can comprise:
a pin integral to the bush and substantially parallel to a generatrix of the bush;
an ring element slidingly mounted to said pin, said ring element arranged to slide along said pin.

Advantageously, the holding portion of the cleaning element and the connection means to the support can be arranged at the opposite ends of the cleaning element.

In particular, the dental floss can be folded in order to form a loop. The dental floss can be, for example, used in combination with an abrasive paste previously applied to the dental surface and/or interdental space to treat.

In an exemplary embodiment, the cleaning element is an abrasive tape, or a tape of different material coated, or soaked with an abrasive material, for example an abrasive paste.

In particular, the eccentric portion can be a removable portion of the drive shaft.

Advantageously, the support is made of a low friction material coefficient, for example PTFE.

In an exemplary embodiment of the invention, the support comprises:
a central body, or core;
a sleeve that is adapted to couple with said central body at respective engagement surfaces.

For example, the sleeve can be slidingly arranged on the core engagement surface up to abut against an edge made at the distal portion of the central body.

Advantageously, the support comprises, furthermore, a ring portion equipped with the connection means that can be arranged, in use, between the edge of the central body and the sleeve.

Furthermore, the support can comprise a disc arranged, in use, at the proximal portion of the support. The core and the disc can be, then fastened to each other by a fastening screw that, in use, crosses the core and the disc at respective holes for eventually screwing at a screw threaded portion of a bush located opposite to the sleeve with respect to the disc.

In particular, the connection means for connecting the cleaning element to the support can comprise:
a plate equipped with two couples of slotted apertures at which the cleaning element engages;
a fastening hole at which the plate is fixed to the support.

Advantageously, the means for transmitting the movement and the cleaning element form a removable insert that can be mounted to the handpiece. In particular, the means for transmitting the movement and the cleaning element are made at an insert having a longitudinal axis, said insert and said dental instrument having a means to provide a mutual engagement of removable type, in order to arrange said longitudinal axis of said insert aligned to said rotation axis of said drive shaft.

Advantageously, the handpiece is a right handpiece. This way, the actions acting on the hand of the user that grips the handpiece are low, and, in particular, are remarkably less than the actions caused by the dental instruments of the prior art.

Advantageously, the cleaning element is a tape of fabric. In this case, the cleaning element is used preferably with an abrasive paste that remains therefore soaked in the fabric and can then apply an highly effective abrasive action.

In an exemplary embodiment, the cleaning element is made of Kevlar®.

Advantageously, the connection means comprises a body having a spherical hole in which engages a spherical head of a pin protruding laterally from the support, said spherical hole and said spherical head arranged to provide a spherical coupling.

Advantageously, the support and the pin of the spherical head are made as a single part.

According to another aspect of the invention, an insert is provided for a dental instrument having a longitudinal axis, said insert and said dental instrument having a means for providing a removable engagement, said dental instrument being equipped with:
a handpiece for a user;
a motor means that is arranged to bring into rotation, with respect to said handpiece, a drive shaft about an axis of rotation; said insert comprising:
an elongated cleaning element arranged for cleaning the interdental spaces and/or the dental surface of a patient, said elongated cleaning element being selected from the group consisting of: a dental floss and a tape of predetermined length;
a means for transmitting the movement of said drive shaft to said elongated cleaning element, said transmission means comprising:
   an eccentric portion of said drive shaft, wherein said eccentric portion, during the rotation of said drive shaft about said axis of rotation, can oscillate with a predetermined oscillation amplitude;
   a support mounted to the eccentric portion and that is adapted to provide with said eccentric portion a rotatable coupling;
   a connection means for connecting said elongated cleaning element to said support, said connection means arranged to support in a stretched way said elongated cleaning element during the rotation of said eccentric portion of said drive shaft, so that said support can be kept rotationally still with respect to the user and can vibrate with respect to the user transmitting the vibration to said stretched cleaning element.

In a further exemplary embodiment, the support has a substantially spherical shape and comprises a first and a second hemispherical portions that can be mutually coupled. The support comprises, furthermore, a ring portion that is adapted, in use, to be arranged between the first and the second hemispherical portions.

In particular, the ring portion has a connection means through which the cleaning element is connected to the support with freedom of movement with respect to it.

Advantageously, the two hemispherical portions are mutually engaged by at least one bolt of fixing.

In addition, or alternatively, the hemispherical portions comprise respective screw-threaded portions that are adapted to couple mutually at the surfaces that, in use, are arranged facing each other.

Advantageously, the holding portion of the elongated element at which the user grips the cleaning element is made at a second handpiece that is grasped by the hand of the user not engaged by the first handpiece.

In particular, the cleaning element can be constrained to the second handpiece by means of second a second connection means. This way, the handgrip of the holding portion of the cleaning element is much steadier and at the same time the specialist can have a position more comfortable posture during the operation.

### BRIEF DESCRIPTION OF THE DRAWINGS

The invention will be now shown with the following description of an exemplary embodiment thereof, exemplifying but not limitative, with reference to the attached drawings in which:

FIG. 1 diagrammatically shows an elevational side view of a dental instrument, according to the invention, for cleaning teeth of a patient;

FIG. 2 diagrammatically shows a part of the dental instrument of FIG. 1 in a longitudinal cross sectional view;

FIG. 3 diagrammatically shows an elevational side view of a possible exemplary embodiment of the dental instrument of FIG. 1;

FIGS. 4 and 5 show diagrammatically a perspective view of a further exemplary embodiment of the dental instrument of FIG. 1 in two different configurations of operation;

FIG. 6 shows a longitudinal cross sectional view of still another exemplary embodiment of the dental instrument of FIG. 1;

FIGS. 7 and 8 show a perspective view of two possible cleaning elements that can be associated with the dental instrument of FIG. 1;

FIGS. 9 and 10 show diagrammatically an elevational side view of further exemplary embodiments of the dental instrument of FIG. 1;

FIG. 11 shows a perspective view of an exploded configuration of a particular exemplary embodiment of the support provided in the dental instrument, according to the invention;

FIG. 12 shows a perspective view of the bush of FIG. 11 in an assembled configuration;

FIG. 13 shows a perspective view of the bush of FIG. 12 installed in an insert for a handpiece;

FIG. 14 shows the support of FIG. 11 in a cross section according to arrows XIV-XIV;

FIG. 15 shows the support of FIG. 13 in a cross section according to arrows XV-XV;

FIGS. from 16 to 18 show a particular exemplary embodiment of the connection means for connecting the cleaning element to the bush;

FIGS. 19 and 20 show a perspective view of a exploded configuration and a perspective view of an assembled configuration a further exemplary embodiment of the bush provided in the dental instrument, according to the invention;

FIG. 21 shows a perspective view of one exemplary embodiment of the holding portion at which the user grips the cleaning element, according to the invention;

FIGS. 22 and 23 show diagrammatically a perspective view of a removed configuration and a perspective view of a engagement configuration of an exemplary embodiment of the connection means for connecting the cleaning element to the bush;

FIGS. 24 and 27 show diagrammatically further exemplary embodiments of the elements of the connection means for connecting the cleaning element to the bush;

FIG. 28 shows an exemplary embodiment of the bush of FIG. 1;

FIGS. 29 and 30 show respectively a perspective view and a cross sectional view of a further exemplary embodiment of the support of FIG. 11;

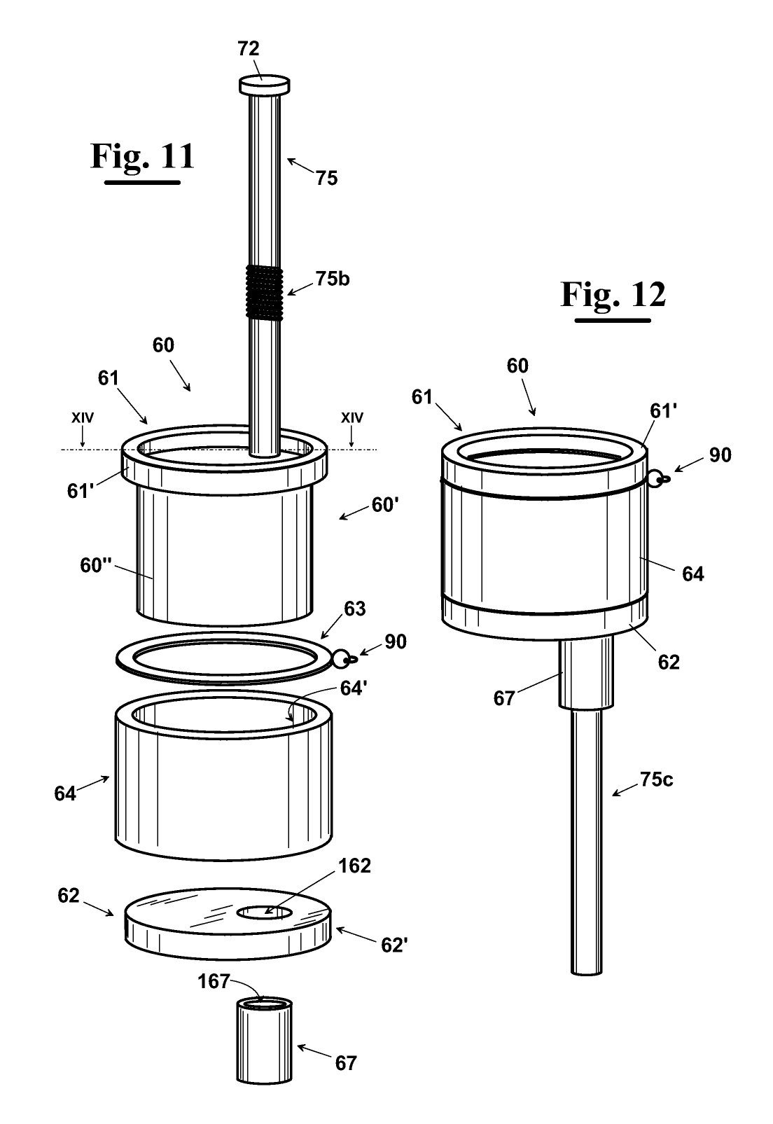

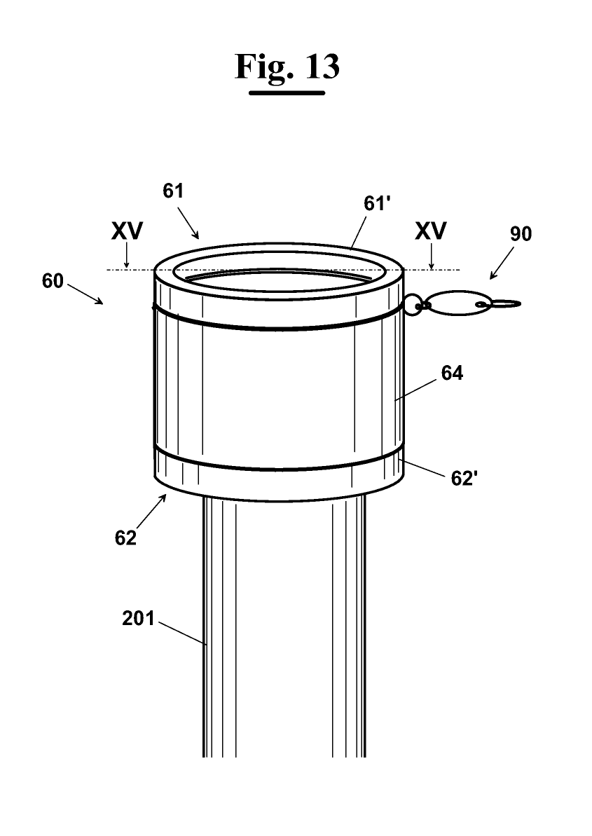

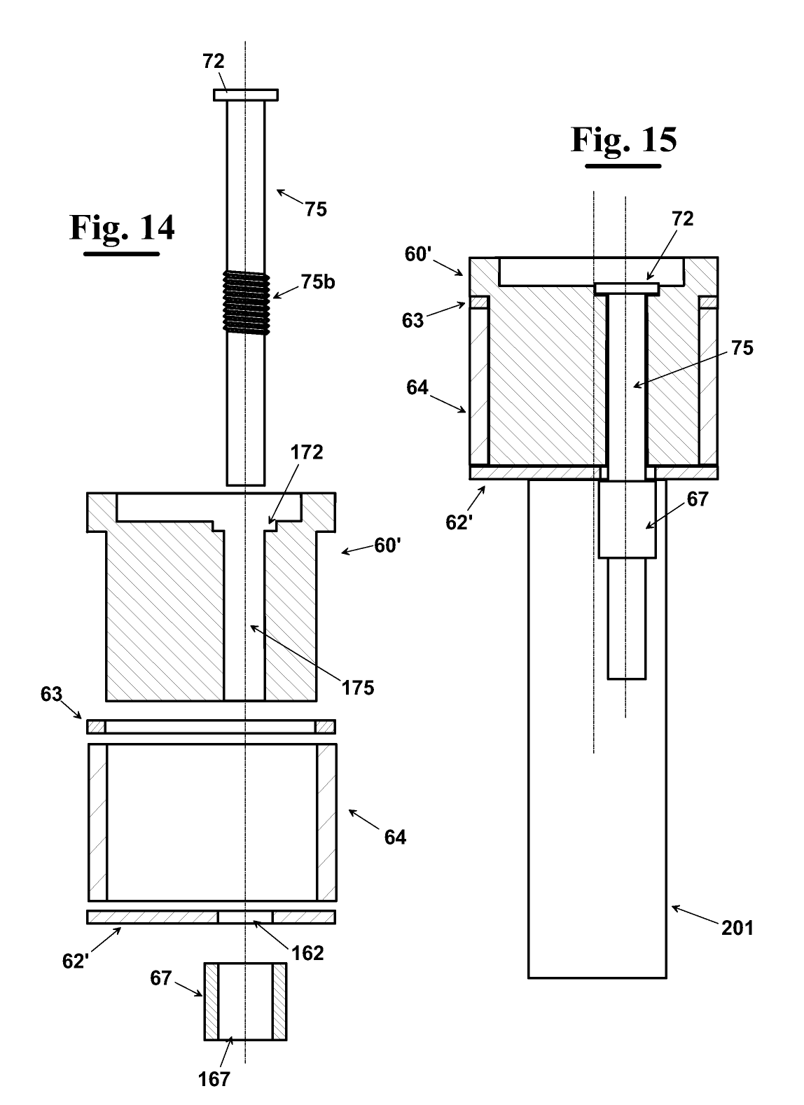

FIGS. from 31 to 33 show other possible exemplary embodiments of the support of FIG. 11.

### DETAILED DESCRIPTION OF SOME EXEMPLARY EMBODIMENTS

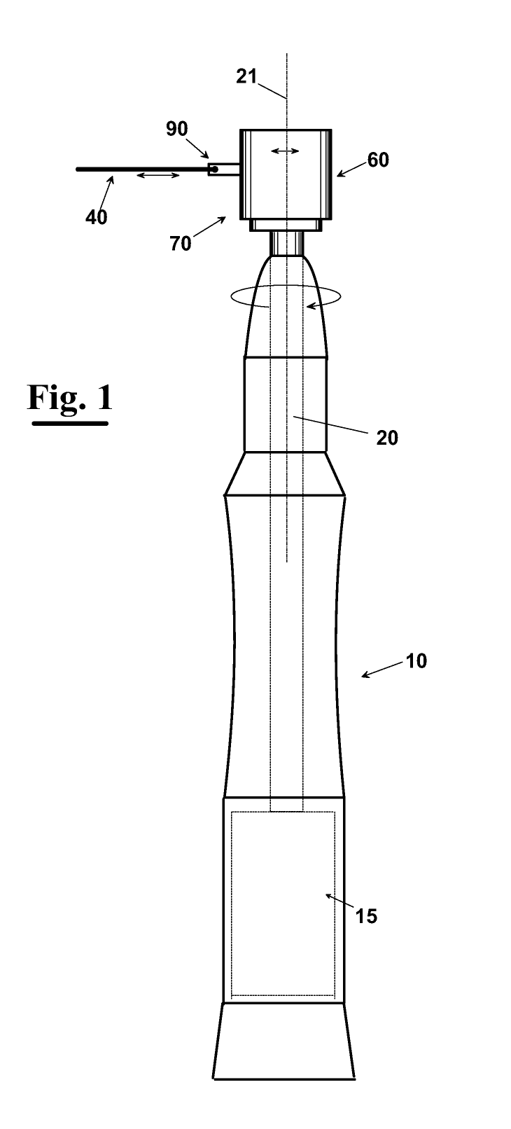

With reference to FIG. 1, a dental instrument 1, according to the invention, comprises a handpiece 10 for a user 50. Handpiece 10 has motor means 15 that is adapted to bring into rotation, with respect to handpiece 10 same, a drive shaft 20 about a rotation axis 21.

Dental instrument 1 comprises, furthermore, a cleaning element 40, in particular, with elongated shape and flexible, such as a dental floss, or a tape, that is adapted for cleaning the dental surface and the interdental spaces of a patient 100. Dental instrument 1 comprises, furthermore, a means for transmitting the movement 70 that is adapted to transmit the movement of drive shaft 20 to elongated cleaning element 40.

In particular, according to the invention, the means for transmitting the movement 70 comprises an eccentric portion 75 whose axis 76 is arranged at a distance 5 from the axis 21 of drive shaft 20. Therefore, during the rotation of drive shaft 20 about its axis 21, eccentric portion 75 vibrates and oscillates with an oscillation amplitude 25. Furthermore, a support 60 is provided, in particular made of a low friction material, for example PTFE to which the eccentric portion engages 75 by a rotatable coupling.

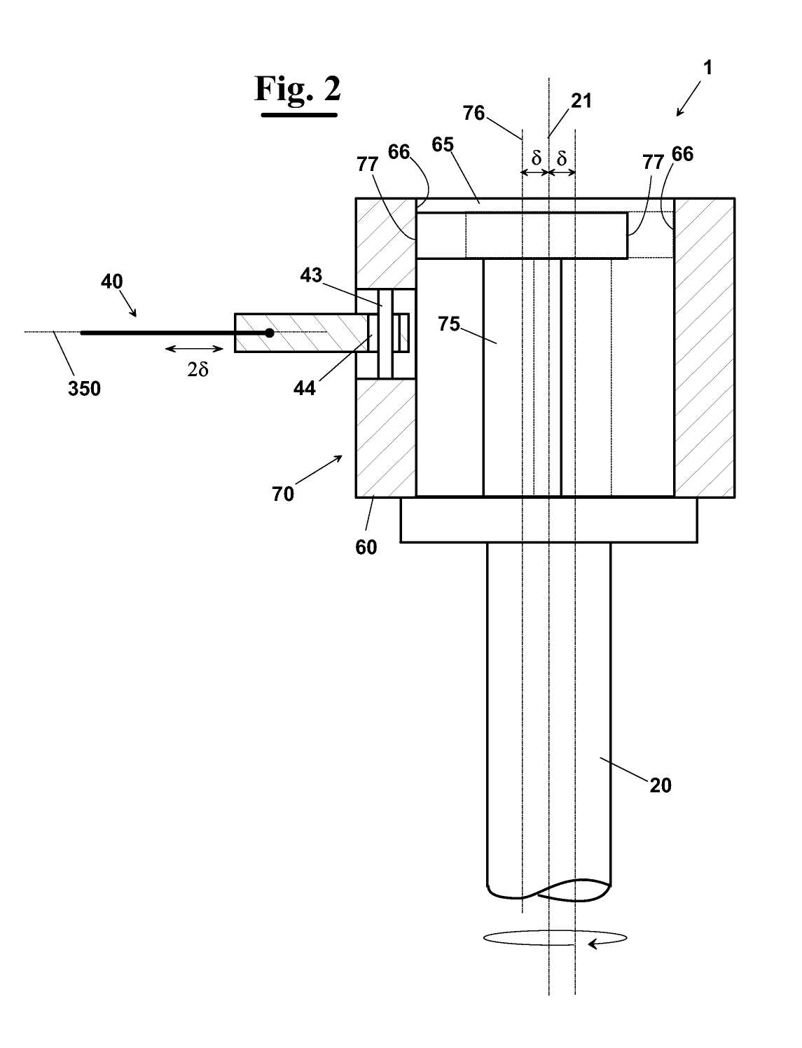

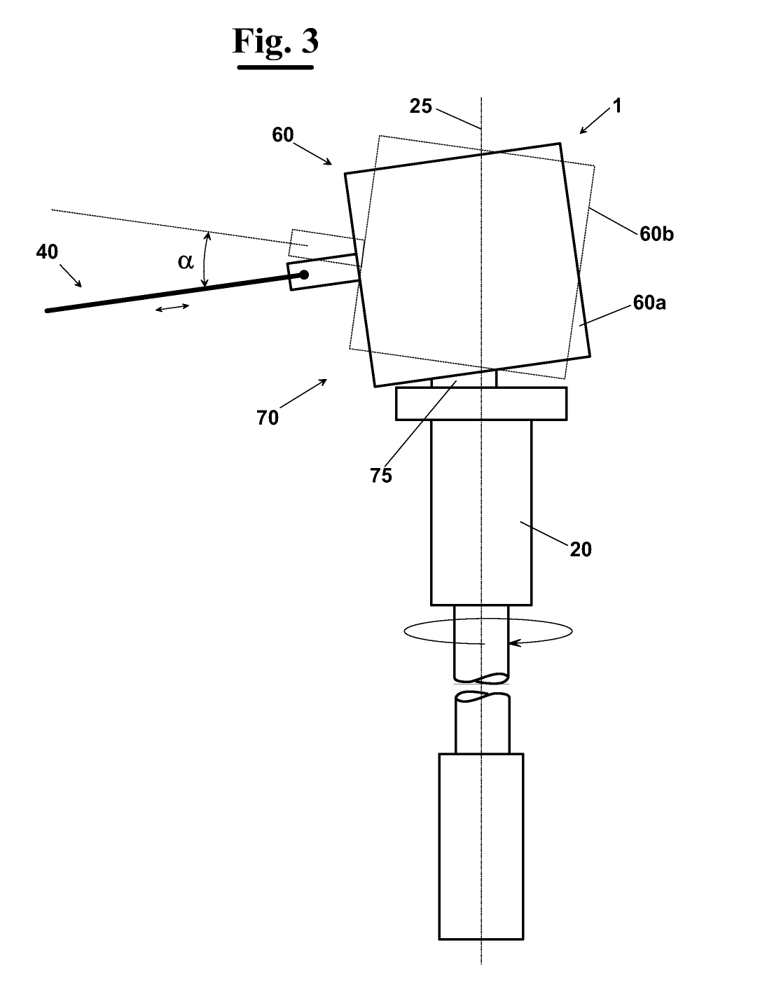

In an exemplary embodiment shown, for example, in FIG. 2, support 60 is a bush 60 equipped with a hole 65 in which the eccentric portion engages 75. More precisely, bush 60 and eccentric portion 75 have, respectively, contact surfaces 66 and 77 at which, in use, the vibration, i.e. the oscillation, of eccentric portion 75 is transmitted to bush 60. Therefore, during the rotation of drive shaft 20 about its rotation axis 21 also bush 60 oscillates with oscillation amplitude 25 along a direction substantially orthogonal to the axis 21 of drive shaft 20. Therefore, cleaning element 40 engaged to bush 60 vibrates and oscillate with oscillation amplitude 25, this way the cleaning the interdental spaces and the dental surfaces with which it is put in contact. This allows to clean teeth also of zones difficult to reach with the dental cleaning instruments of prior art. In particular, it is possible cleaning contact surfaces of two adjacent teeth.

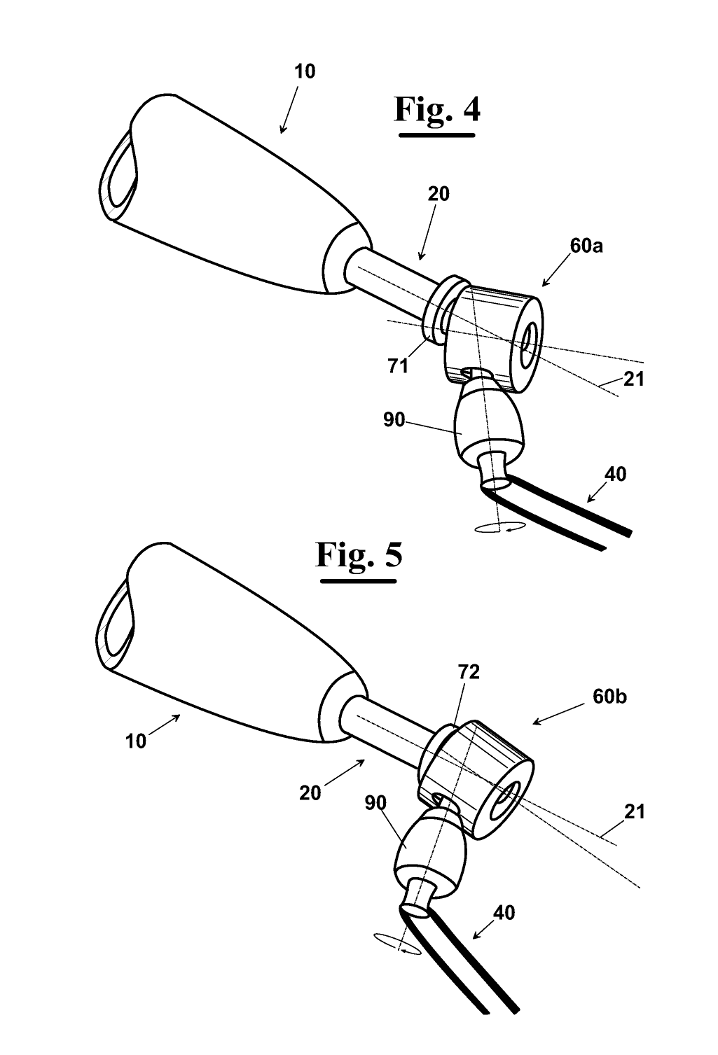

In an exemplary embodiment, bush 60 engages with eccentric portion 75 of drive shaft 20 at a hole 65, for example an elongated hole, having a cross section S1 of size larger than the cross section S2 of eccentric portion 75. Therefore, eccentric portion 75 engages hole 65 with a predetermined radial play. This allows to incline bush 60 with respect to drive shaft 20. More precisely, bush 60 can be at an angle with respect to eccentric portion 75 between a first angular position 60a (FIG. 4) and a second angular position 60b (FIG. 5) arranged at an angular distance a with a predetermined oscillation amplitude.

In particular, handpiece 10 can be a right handpiece. This reduces remarkably, in operation conditions, the actions acting on the hand of user 50 who grips handpiece 10. More precisely, the use of a right handpiece 10 reduces the couple generated by the rotation of drive shaft 20 and that would act on the hand that grips the dental instrument.

Bush 60 can be, furthermore, constrained to eccentric portion 75, in order to have a axial play that makes it possible to a relative sliding. In particular, a first and a second stop elements 71 and 72 can be provided adapted to contain longitudinally bush 60. More precisely, the distance “d” between the first and the second stop element 71, 72 causes the freedom of movement of bush 60 with respect to eccentric portion 75.

For example, first stop element 71 can be a disc integral to drive shaft 20 and can have size larger than hole 65, such that it stops the movement of bush 60 along drive shaft 20 towards handpiece 10. The second stop element 72 can be, instead, a shoulder of the enlarged portion of eccentric portion 75.

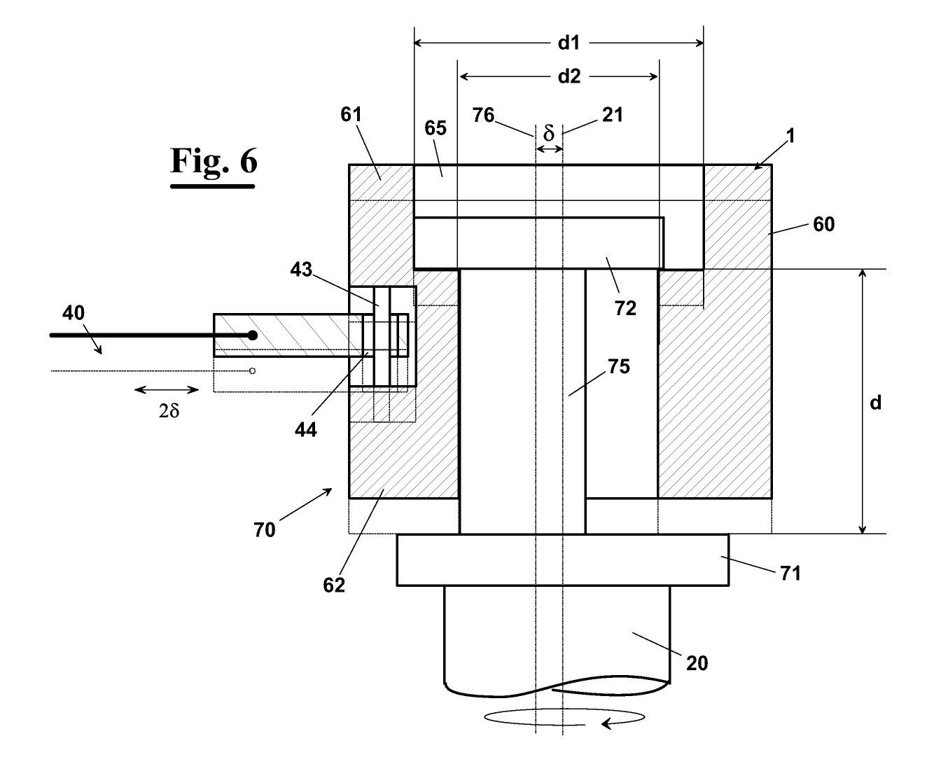

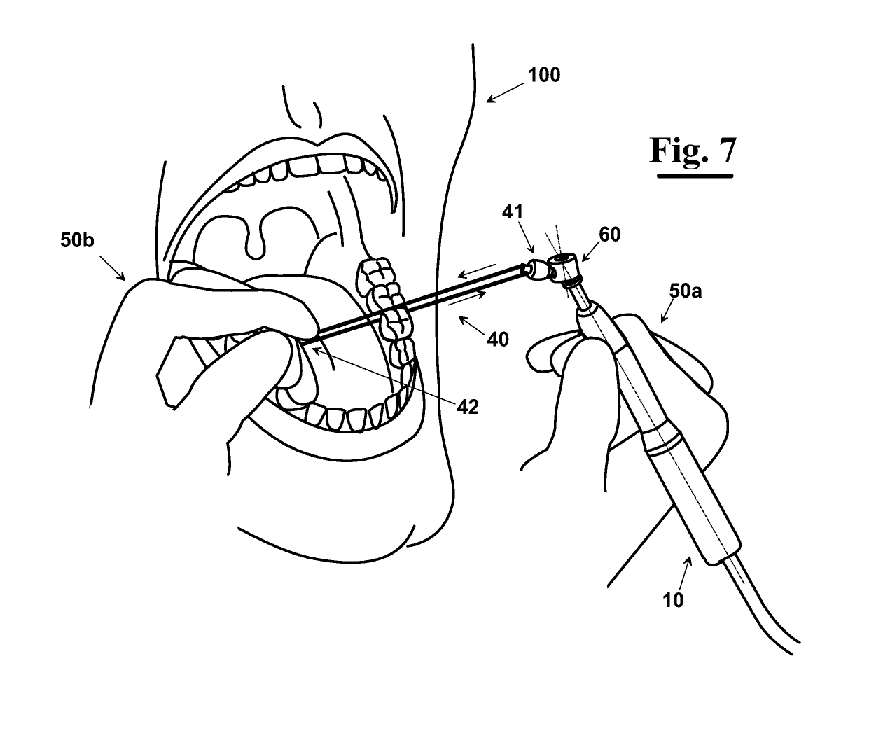

In the exemplary embodiment, as shown in FIG. 6, hole of bush 60 comprises a distal portion 61 having a diameter d1 larger than the size of the cross section of stop element 72 and a proximal portion 62 having diameter d2 less than the size of the cross section of stop element 72. Therefore, bush 60 is free of moving between the disc 71 and enlarged portion 72 of the eccentric portion.

In a further exemplary embodiment, cleaning element 40 can be constrained to bush 60 by a connection means 90 that allow a relative inclination. For example, connection means 90 comprises a pin 43 integral to bush 60 and substantially parallel to a generatrix of bush 60 same and a ring element, or a hole 44, slidingly mounted to pin 43.

In addition, or alternatively, connection means 90 can provide a rotatable coupling between bush 60 and cleaning element 40.

Connection means 90 can, furthermore, comprise an end 91 hinged to bush 60 at a point 95, such that cleaning element 40 is at an angle with respect to eccentric portion 75 within an angle β of predetermined oscillation amplitude, for example set between 0° and 180°, advantageously between 10° and 170°.

Cleaning element 40 has an embracing portion 41 in which it is constrained to bush 60 and a holding portion 42 for user 50. Dental instrument 1 thus obtained allows user 50 to guide cleaning element 40 with hand 50b acting on holding portion 42. Owing to the large number of degrees of freedom of cleaning element 40, user 50 can easily clean the teeth of the whole surface of the dental arch of the patient 100 comprising also the most hidden points, such as the contact surfaces of the teeth, rotating and/or inclining without difficulty hand 50b. Therefore, when cleaning the teeth user 50 has not the need of inclining and/or rotating the wrist of the hand 50a with which handpiece 10 is held, which that can be kept in a comfortable position. In fact, as above described, differently from similar devices of the prior art, hand 50b, is not subject to strong actions, guiding the trajectory of cleaning element 40 in a space up to the area of operation.

As shown in FIGS. from 1 to 7, cleaning element 40 can be a dental floss of determined length. The dental floss 40 can be folded in order to form a loop, or ring, for being used in combination with an abrasive paste previously applied to the dental surface and/or at the interdental space to treat.

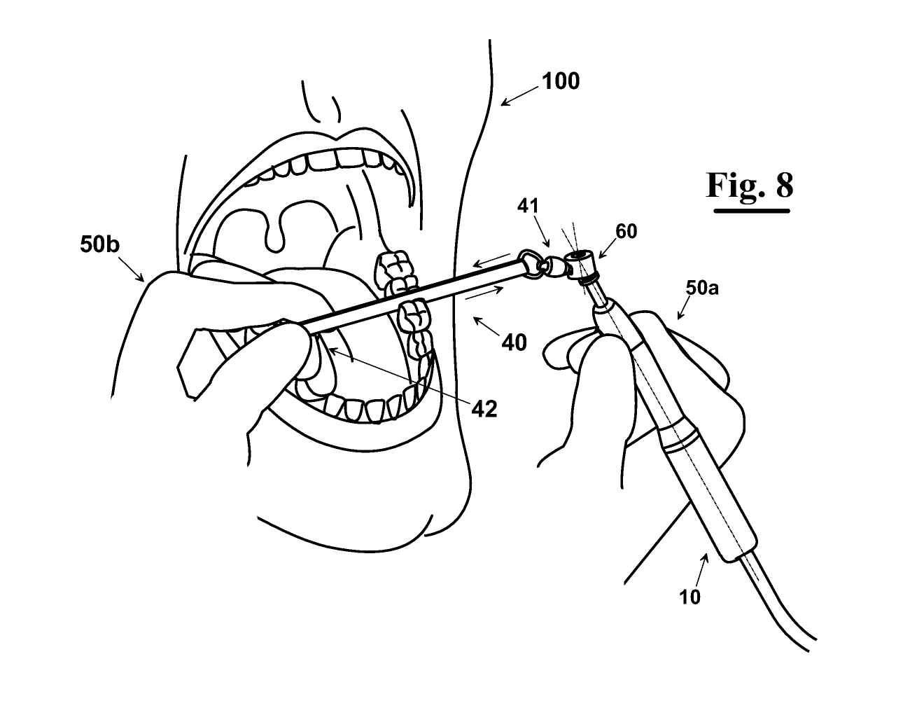

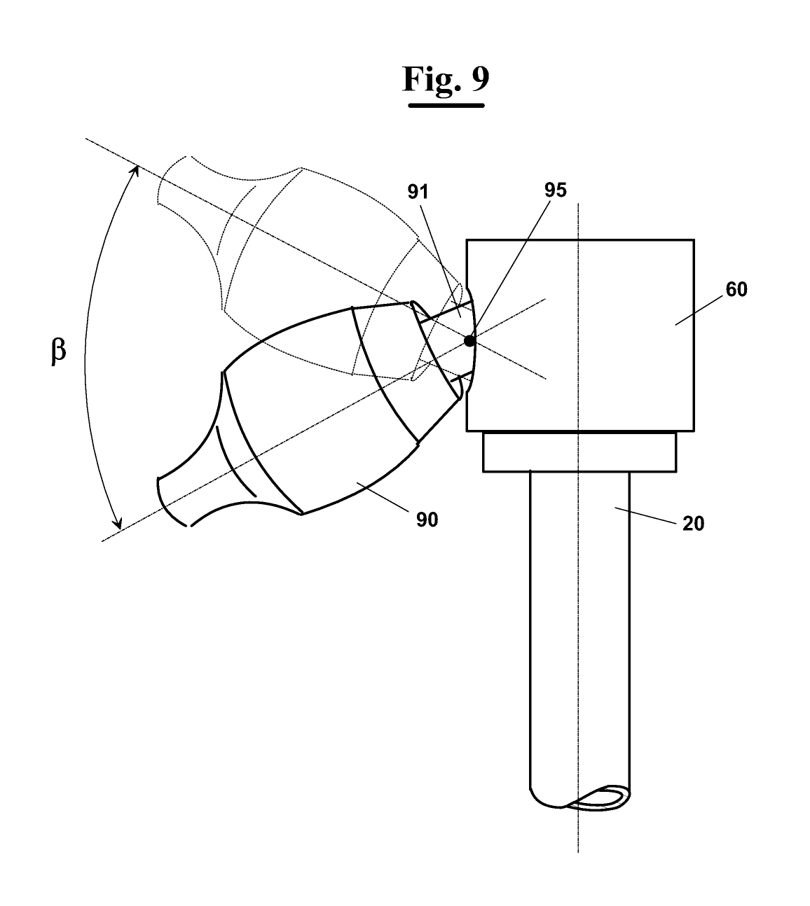

In the exemplary embodiment, as shown in FIG. 8, cleaning element 40 is a tape of abrasive material of measured length constrained at one end 41 to bush 60 and maneuvered by user 50 at the opposite end 42 along a predetermined stretching direction 350.

Eccentric portion 75 can be a removable portion from drive shaft 20 and to it connected by means of a snap engagement, or screwed engagement, or another type of engagement.

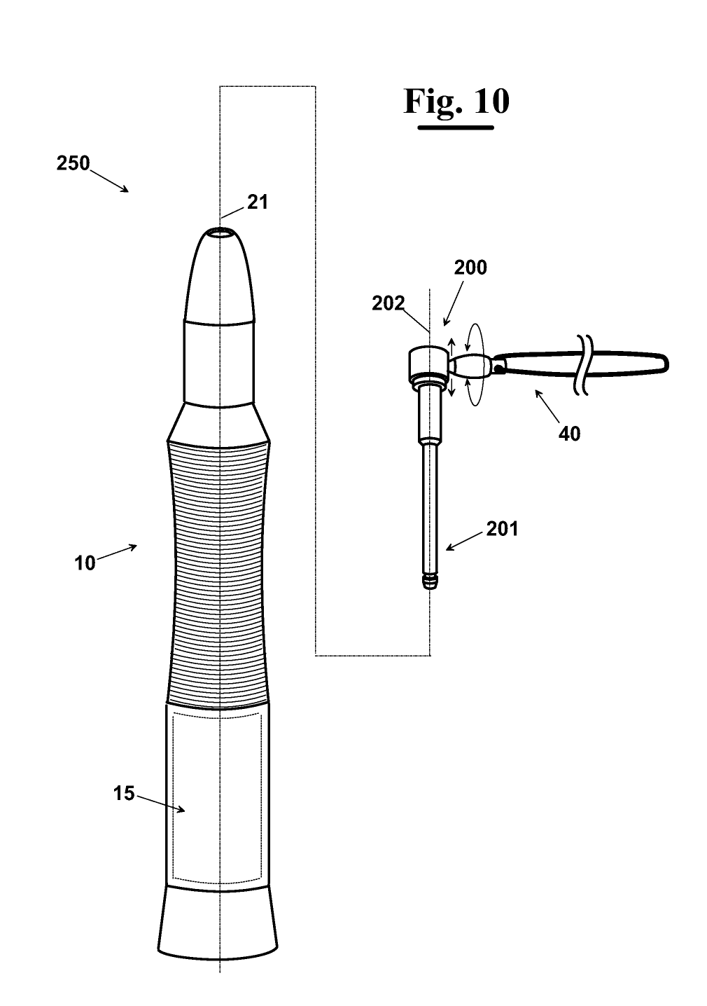

In the exemplary embodiment shown in detail in FIG. 10, the means for transmitting the movement 70 and cleaning element 40 are made as an insert 200 for a dental instrument 250. In particular, the insert 200 comprises a fastening portion 201 at which engages, for example with a click engagement, handpiece 10 and that is adapted, in use, to couple to drive shaft 20 of the dental instrument, in order to be put coaxially to it. More precisely, the insert 200 has a longitudinal axis 202 that in use is aligned to the rotation axis 21 of drive shaft 20.

In FIGS. from 11 to 15, an exemplary embodiment is shown of bush 60 comprising a core 60′ and a sleeve 64 coupled to each other at engagement surfaces 60″ and 64″ respectively. More precisely, sleeve 64 is adapted to slide on engagement surface 60″ of core 60′ up to abut against an edge 61′ made at the distal portion 61 of core 60′ same. Bush 60 comprises, furthermore, a ring portion 63 that is adapted, in use, to be arranged between the edge 61′ of core 60′ and sleeve 64. More precisely, ring portion 63 has a connection means 90 through which cleaning element 40 is connected to bush 60.

Sleeve 64 is kept in position with respect to core 60′ by a disc 62′ that, in use, is arranged at the proximal portion 62 of bush 60. Core 60′ and disc 62′ are locked by a fastening screw 75 that, in use, crosses core 60′ at a hole 175 and disc 62′ at a hole 162, for then screwing at a screw threaded portion 75b in a screw threaded hole 167 of a bush 67, in order to fix disc 62′ against sleeve 64. Lock screw 75 has an enlarged head 72 that is adapted, in use, to be put at a countersunk portion 172 made in the hole 175. The screw 75 is then connected to the fastening portion 201 of the insert 200 through which it is connected to handpiece 10.

In an exemplary embodiment, as shown in FIGS. from 16 to 18, cleaning element 40, both in case of a dental floss and in case of a abrasive tape, can be constrained to bush 60 by means of a connection element 160 comprising a plate equipped with two couples of slotted apertures 163a-163b and 163c-163d and of a hole 168 in which it is fixed to the engagement elements 90 of bush 60.

In the case shown in FIGS. 17 and 18, cleaning element 40 is a tape comprising a abrasive surface 45 that in operation conditions is put in contact of the dental surface to treat. More precisely, in use, tape 40 passes through the first couple of slotted apertures 163a-163b and remains below wing 165 comprised between them. Tape 40 passes also through slotted apertures 163c-163d and is folded about wing 166, comprised between them, for being then put again between slotted apertures 163b and 163a. This way, between slotted apertures 163a-163b and slotted apertures 163c-163d, tape 40 has overlapped portions of abrasive surface 45. Therefore, for the features of the abrasive surface 45 it is possible to provide an autolocking tape 40, which during the use of the tool 40 remains in a correct operation position.

In a further exemplary embodiment, not shown in the figures, plate 160 can be equipped with a locking tang movable between a sliding position in which it allows the sliding of the cleaning element with respect to said plate, and a locking position in which it is adapted to push cleaning element 40 against the surface of plate 160 and to prevent it from sliding with respect to said plate.

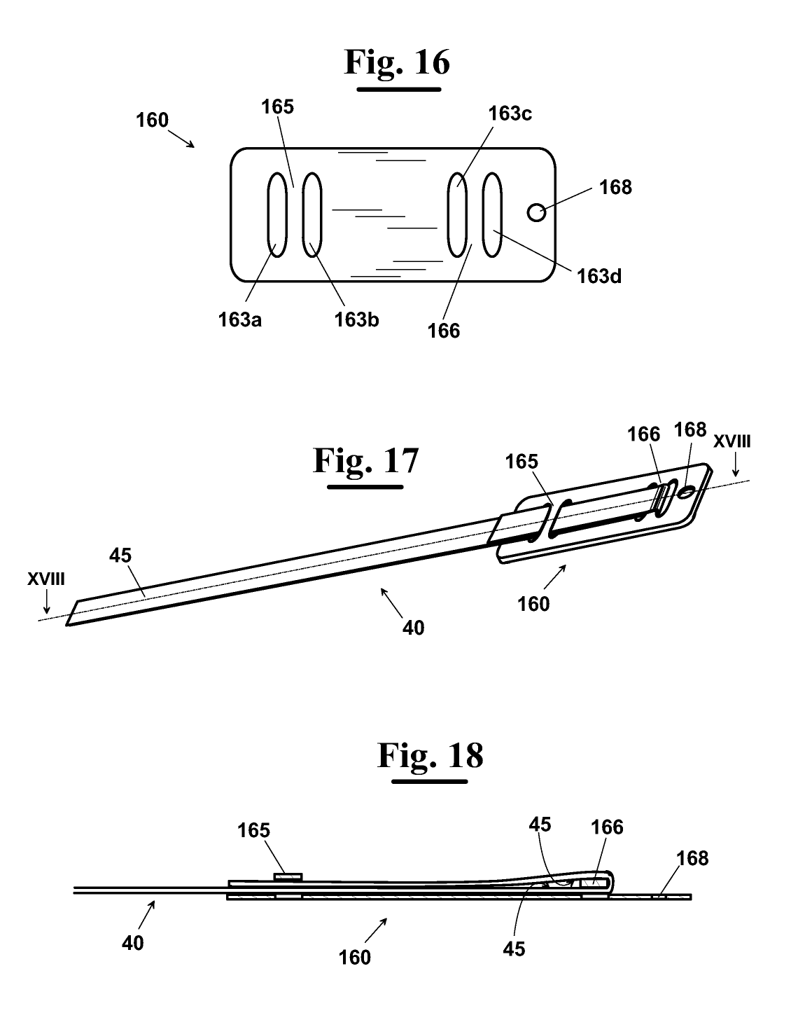

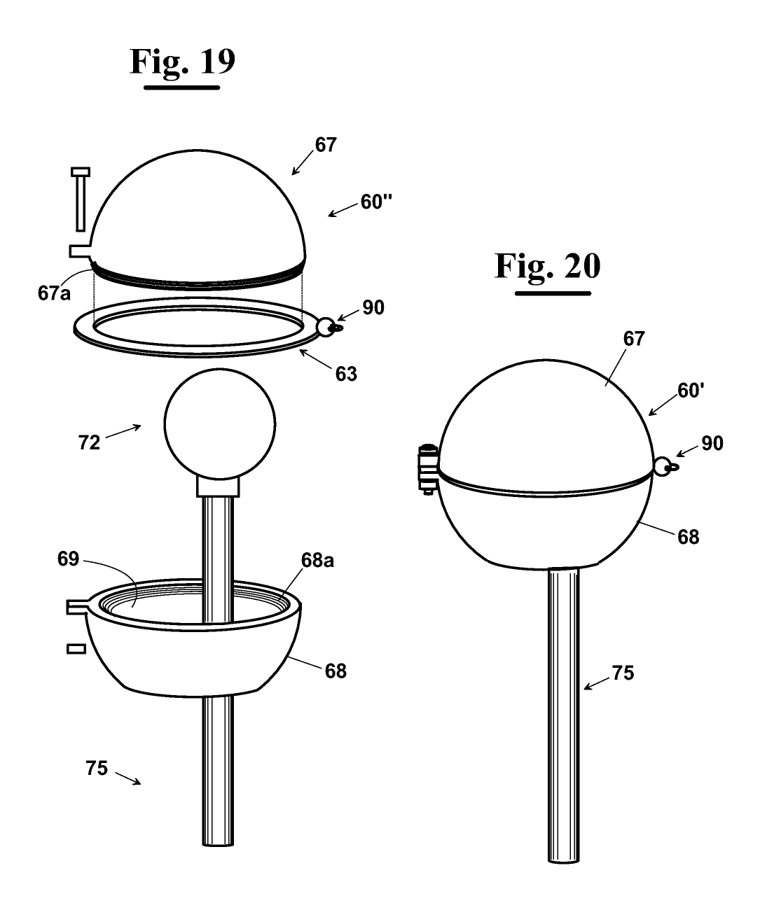

In a further exemplary embodiment diagrammatically shown in FIGS. 19 and 20, support 60 has a substantially spherical shape and comprises a first and a second hemispherical portions 67, 68 that can be mutually coupled. Support 60 comprises, furthermore, a ring portion 63 that is adapted, in use, to be arranged between the hemispherical portions 67 and 68 of the support. Ring portion 63 has connection means 90 through which cleaning element 40 is connected to support 60 with freedom of movement with respect to it.

The two hemispherical portions 67 and 68 can be mutually engaged by at least one fastening bolt 69. In addition, or alternatively, the hemispherical portions 67 and 68 comprise respective screw-threaded portions 67a and 68a that are adapted to provide a screw threaded matching. Ring portion 63 is, therefore, fastened between the two screw-threaded portions 67a and 68a.

In this case, the fastening portion 201 through which the insert 200 engages with handpiece 10 comprises an enlarged portion 72. It can be arranged at the free end of the fastening portion and can have a substantially spherical shape. More precisely, in operation conditions, the enlarged portion 72 hits, in use, the inner wall 69 of support 60 for transferring the vibratory movement and then causing a predetermined oscillation.

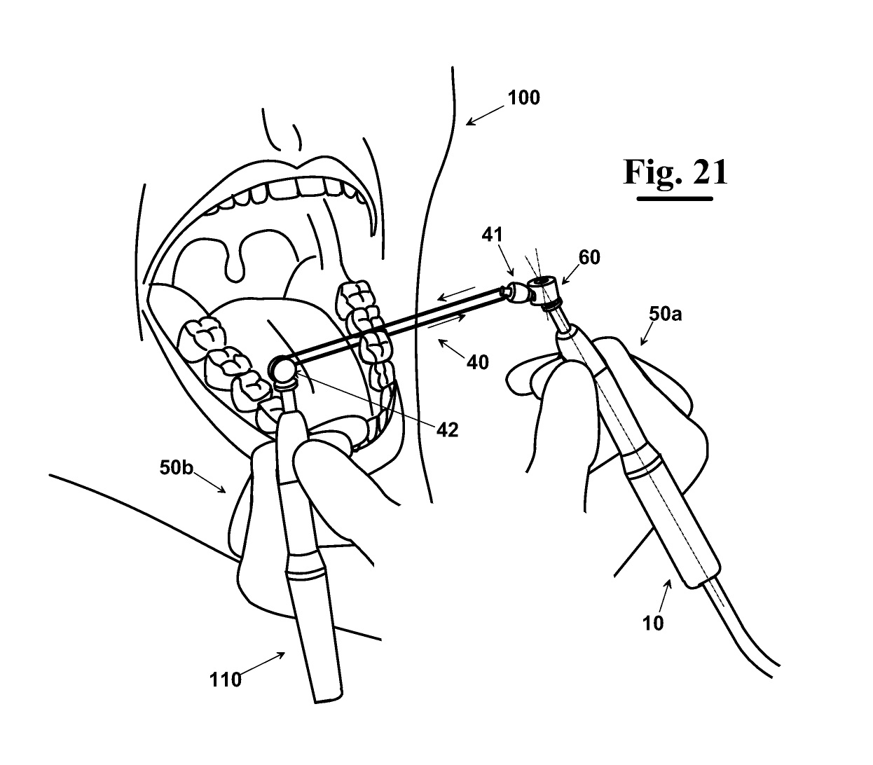

In FIG. 21 one exemplary embodiment is shown of holding portion 42 at which the user grips cleaning element 40. In this case a second handpiece 110 can be provided that is grasped by hand 50b of the user not engaged by the first handpiece 10, which has support 60. More precisely, cleaning element 40 is constrained to the second handpiece 110 by means of second connection means 190. This way, the handgrip of the holding portion of cleaning element 40 is much steadier and at the same time the specialist can have a more comfortable posture during the operation. The second connection means 190 can, for example, comprise an idle pulley, or a pivot capable of ensuring a certain freedom of movement of cleaning element 40 with respect to second handpiece 110.

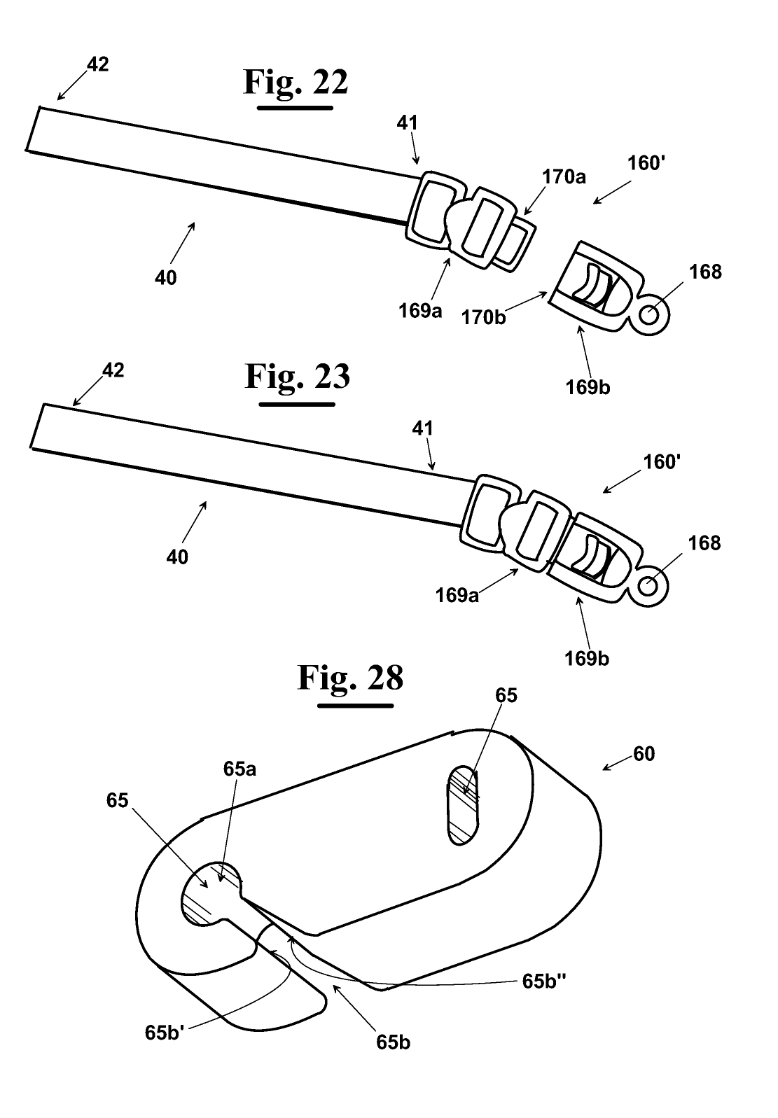

In a further exemplary embodiment, as shown in FIGS. 22 and 23, cleaning element 40, both in case of a dental floss and in case of an abrasive tape, can be constrained to support 60 by means of a connection element 160′ with a click engagement. More precisely, connection element 160′ comprises a first and a second part 169a and 169b has means for engaging/disengaging of click type. More precisely, part 169a and part 169b, at the respective facing surfaces, comprise a protrusion 170a that is adapted to snap engage with a housing 170b.

In particular, part 169a has a means 180 for blocking cleaning element 40 and for causing at the same time an easy unlock for causing it to slide, in order to use gradually different successive abrasive portions. Part 169b is, instead, equipped with a hole 168 for constraining it to support 60.

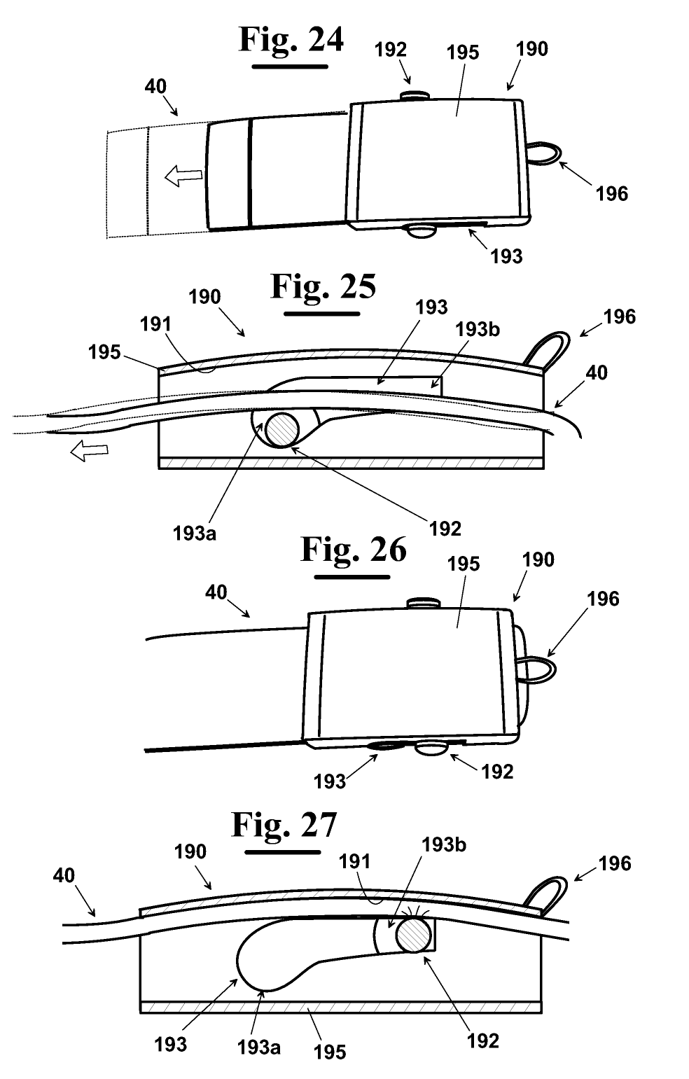

In still a further exemplary embodiment, as shown in FIGS. from 24 to 27, cleaning element 40 can be constrained to support 60 by means of a connection element 160″ comprising a lock means 190 movable between a first position, in which it allows a free sliding cleaning element 40 (FIGS. 24 and 25) and a second position, in which it blocks cleaning element 40 against an abutment surface 191 (FIGS. 26 and 27). In particular, lock means 190 comprises a rod 192 movable in a groove 193 made in a body 195. It has an hanging element 196 in which it is fixed to the engagement elements 90 of support 60. Groove 193 has a portion 193a at a distance from the abutment surface 191 and a portion 193b approached to the abutment surface 191. More precisely, when rod 192 is arranged in portion 193a of groove 193, its distance from surface 191 is higher than the thickness of cleaning element 40. Therefore, in this working configuration cleaning element can slide freely with respect to surface 191. When, instead, rod 192 is arranged in portion 193b of groove 193, its distance from surface 191 is less than the thickness of cleaning element 40. Therefore, in this working configuration rod 192 blocks cleaning element 40 against surface 191 preventing it from sliding.

In an exemplary embodiment not shown in the figures, lock means 190 can comprise a blocking element movable between a configuration, where “grips” cleaning element 40, preventing it from sliding and a free configuration of cleaning element 40 to make it possible a free sliding.

In FIG. 28 an exemplary embodiment is shown of support where hole 65 is open, i.e. it ends at the outer surface of support 60. In this case hole 65 has a central portion 65a in which eccentric portion 75 is arranged through side portion 65b, forcing resiliently against side walls 65′b and 65″b. Once put in portion 65a eccentric portion 75 remains pivotally engaged with support 60. Support 60 is then constrained to connection means 90 at a groove 65c.

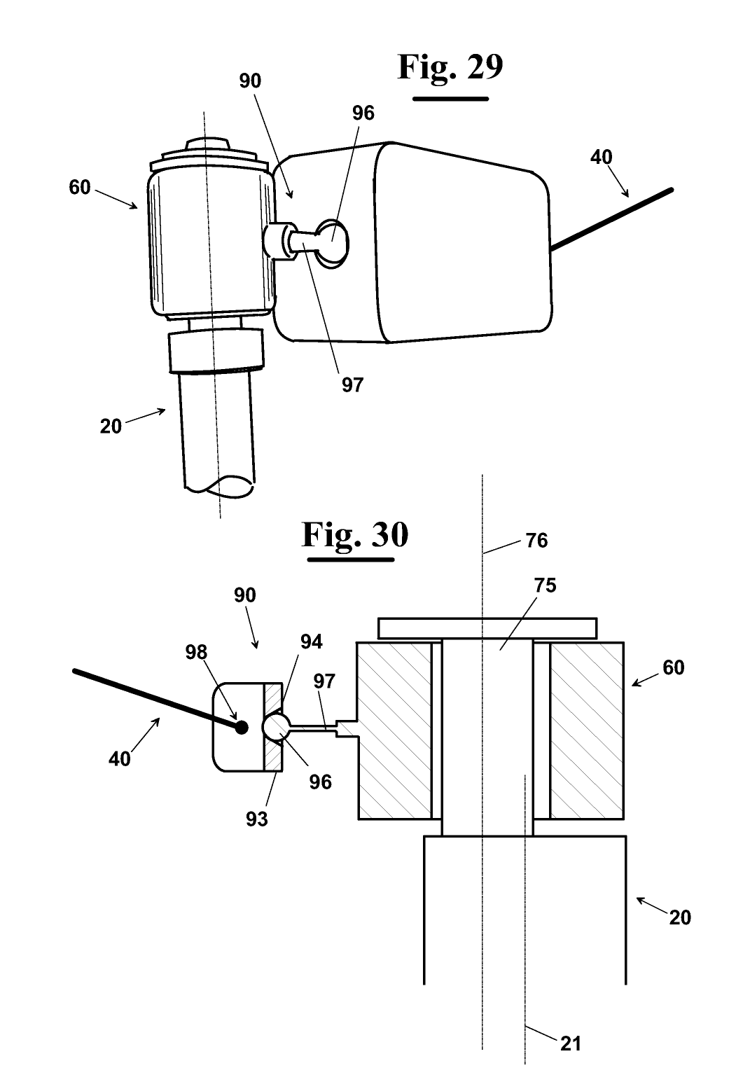

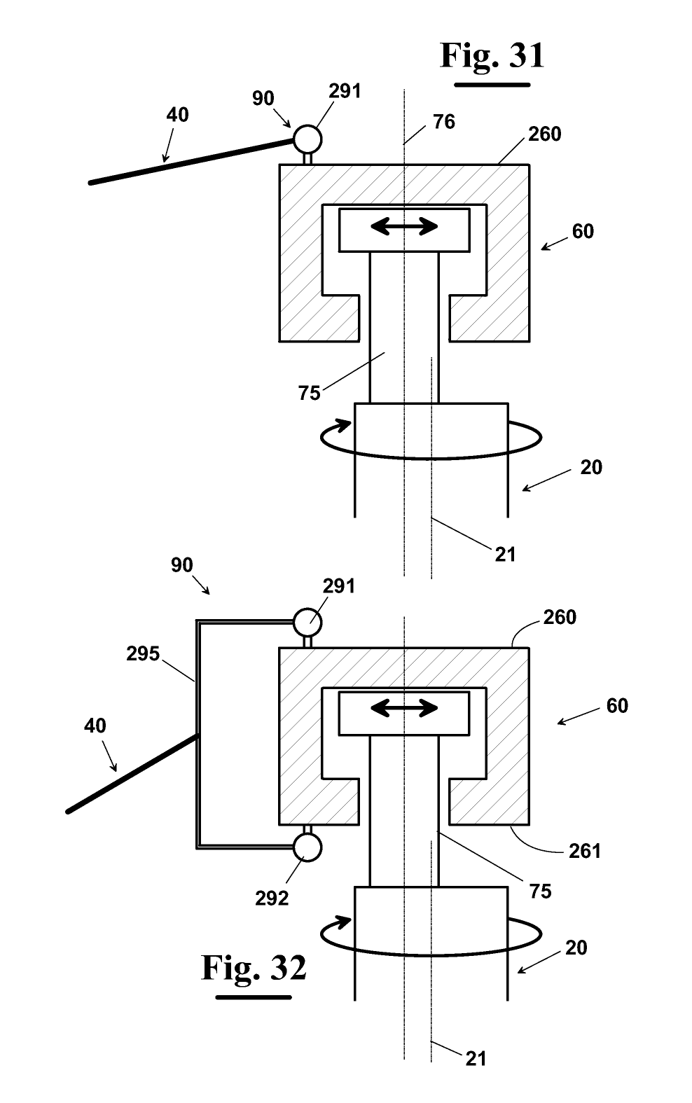

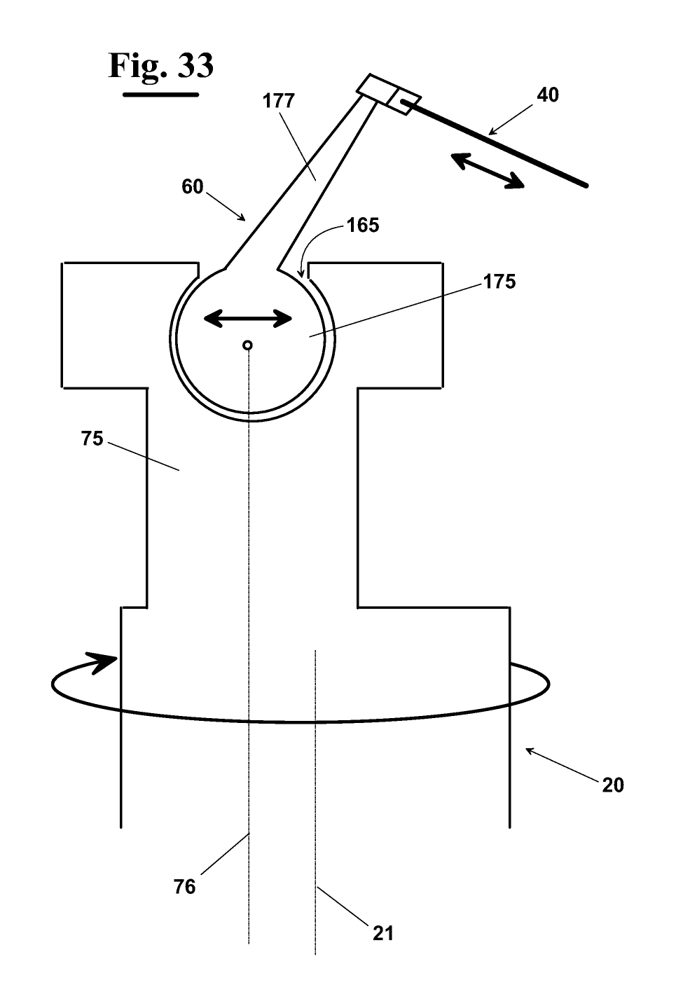

In the exemplary embodiment, as shown in FIGS. 29 and 30, cleaning element 40 is constrained to support 60 by a connection means 90 comprising a body 93 having a hole 94, for example spherical, in which a spherical head 96 engages of a pin 97 protruding from support 60 to provide a spherical coupling. More in detail, cleaning element 40 is constrained to a support rod 98 whose position is indicated in FIG. 30. In the case shown in FIGS. 29 and 30, support 60 and pin 97 with the spherical head 96 are made as a single part.

In another exemplary embodiment, as shown in FIGS. 31 and 32, support 60 has a blind hole 65 in which the eccentric portion engages 75, and a surface 260, substantially orthogonal to axis 76, at which connection means 90 is arranged. They can comprise a ring 291 to which the dental floss, or tape 40 is constrained, for example tied. Alternatively, connection means 90 can provide a spherical coupling. In the case of FIG. 32, the connection means comprises two portions 291 and 292 protruding from respective surfaces 260 and 261 of support 60 among which a support element 295 extends with which cleaning element 40 engages.

In the further exemplary embodiment, as shown in FIG. 33, support 60 comprises a portion 175 that is eccentric to shaft 20, arranged in a housing 165 made in shaft 20. Support 60 comprises, furthermore, an arm 177 with which cleaning element 40 engages. Even in this case, as already described for an exemplary embodiments shown in FIGS. from 1 to 31, during the rotation of shaft 20 of handpiece 10, eccentric portion 175 vibrates in housing 165 and cleaning element 40 to it constrained to vibrate as well.

The foregoing description of a specific embodiment will so fully reveal the invention according to the conceptual point of view, so that others, by applying current knowledge, will be able to modify and/or adapt for various applications such an embodiment without further research and without parting from the invention, and it is therefore to be understood that such adaptations and modifications will have to be considered as equivalent to the specific embodiment. The means and the materials to realise the different functions described herein could have a different nature without, for this reason, departing from the field of the invention. It is to be understood that the phraseology or terminology employed herein is for the purpose of description and not of limitation.

1. Dental instrument (1) comprising:
a handpiece (10) for a user (50);
a motor means (15) that is adapted to bring into rotation, with respect to said handpiece (10), a drive shaft (20) about a rotation axis (21);
an cleaning element (40) with elongated shape that is adapted for cleaning the interdental spaces and/or the dental surface of a patient (100), said elongated cleaning element (40) selected from the group consisting of: a dental floss and a tape of predetermined length;
a means for transmitting the movement (70) of said drive shaft (20) to said elongated cleaning element (40), said means for transmitting the movement (70) comprising:
an eccentric portion (75) of said drive shaft (20), said eccentric portion (75) arranged to oscillate with a predetermined oscillation amplitude (25) during the rotation of said drive shaft (20) about said rotation axis (21);
a support (60) pivotally connected to said eccentric portion (75);
a connection means (90) for connecting said elongated cleaning element (40) to said support (60), said connection means arranged to support in a stretched way said elongated cleaning element along a predetermined stretching direction during the rotation of said eccentric portion (75) of said drive shaft, so that said support can be kept rotationally still with respect to the user and can vibrate with respect to the user transmitting the vibration to said stretched cleaning element.

2. Dental instrument, according to claim 1, wherein said support is a bush (60) having a hole (65) in which said eccentric portion (75) engages such that said bush (60) forms a rotatable coupling with said eccentric portion (75).

3. Dental instrument, according to claim 1, wherein said support (60) has a hole at which said eccentric portion engages pivotally with said support.

4. Dental instrument, according to claim 2, wherein said hole (65) has radial size larger than the radial size of said eccentric portion (75), therefore said support (60) is mounted to said eccentric portion (75) with a predetermined radial play such that said support (60) is movable radially with respect to said eccentric portion (75), allowing to change the stretching direction (350) in a desired way.

5. Dental instrument, according to claim 2, wherein said radial play is adapted to allow an inclination of said support with respect to an axis of said handpiece of an angle set between +180° and −180°.

6. Dental instrument, according to claim 2, wherein said radial play is adapted to allow an inclination of said support with respect to an axis of said handpiece of an angle set between +120° and −120°.

7. Dental instrument, according to claim 2, wherein said support (60) is movable longitudinally to said eccentric portion (75) between a first position and a second position.

8. Dental instrument, according to claim 7, wherein at said first and said second position a first and a second stop element (71, 72) are provided respectively, said first and said second stop elements (71, 72) defining the movement of said support (60) with respect to said eccentric portion (75) between said first and said second position.

9. Dental instrument, according to claim 8, wherein said first stop element is a disc integral to said drive shaft, said disc having size larger than said hole to stop the movement of said support along the eccentric portion of said drive shaft.

10. Dental instrument, according to claim 8, wherein said second stop element comprises a shoulder at said eccentric portion, said shoulder arranged, at said second position, to abut against a portion protruding from said hole.

11. Dental instrument, according to claim 10, wherein said hole comprises:
a distal portion having a cross section with a predetermined dimension;
a proximal portion having a cross section of size less than the cross section of the distal portion, in order to form said protruding portion.

12. Dental instrument, according to claim 1, wherein said support comprises:
a central body, or core;
a sleeve that is adapted to couple with said central body at respective engagement surfaces.

13. Dental instrument, according to claim 1, wherein said connection means is arranged to provide a rotatable coupling between said support (60) and said elongated cleaning element (40), such that, in use, said elongated cleaning element (40) can rotate with respect to said support (60) in order eliminate the torsion of said elongated cleaning element (40).

14. Dental instrument, according to claim 1, wherein said connection means (90) comprises an end (91) hinged to said support (60), such that said elongated cleaning element (40) can be freely rotated with respect to said support (60) in a plane containing said direction (350) and said drive shaft (20).

15. Dental instrument, according to claim 1, wherein said connection means (90) comprises:
a pin (43) integral to said support (60) and substantially parallel to a generatrix of said support (60);
an ring element (44) slidingly mounted to said pin (43), said ring element (44) adapted to slide along said pin (43).

16. Dental instrument, according to claim 1, wherein said means for transmitting the movement (70) and said elongated cleaning element (40) form a removable insert (200) which can be fixed to said handpiece (10).

17. Dental instrument, according to claim 1, wherein said dental floss is folded in order to form a loop.

18. Dental instrument, according to claim 1, wherein said tape is selected from the group consisting of:
a abrasive tape;
a tape of fabric;
a tape of fabric soaked with abrasive paste.

19. Dental instrument, according to claim 1, wherein said connection means comprises a body having a spherical hole in which a spherical head engages of a pin protruding laterally from said support, said spherical hole and said spherical head arranged to provide a spherical coupling.

20. Dental instrument, according to claim 19, wherein said support and said pin with said spherical head are made as a single part.

21. Dental instrument, according to claim 1, wherein said connection means comprises:
a plate equipped with two couples of slotted apertures at that engage with said elongated cleaning element;
a fastening hole at which said plate is fixed to said support.

22. Dental instrument, according to claim 1, wherein said handpiece is a right handpiece, such that the actions acting on the hand of a user that grips said handpiece are low.

23. Dental instrument, according to claim 1, wherein said support has a substantially spherical shape and comprises:
a first and a second hemispherical portions that can be mutually coupled;
a ring portion that is adapted, in use, to be arranged between said first and said second hemispherical portions, said ring portion being equipped with said second connection means.
